(19) United States
(12) Patent Application Publication
(10) Pub. No.: US 2009/0276770 A1
(43) Pub. Date: Nov. 5, 2009

(54) SYSTEMS, METHODS AND COMPUTER PROGRAM PRODUCTS FOR AUTOMATING PACKAGING AND PROVISIONING OF J2EE WEB MODULES TO ECLIPSE-BASED RICH CLIENTS

(75) Inventors: David Taieb, Charlestown, MA (US); Margaret M. O'Connell, Allston, MA (US); Hanna Russo, Newton, MA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/112,984

(22) Filed: Apr. 30, 2008

(51) Int. Cl. G06F 9/445

(52) U.S. Cl. 717/177

(57) ABSTRACT

Systems, methods and computer program products for automating packaging and provisioning of J2EE Web Modules to Eclipse-based Rich Clients. Exemplary embodiments include a method including deploying an application to an application server being packaged as a plugin, publishing the application to a dynamic update site, connecting to the dynamic update site, selecting the application having the web modules for provisioning, versioning each component of the application, determining interdependencies of each component, determining user access control for each component, generating feature and plugin jar files from each component, signing the feature and plugin jar files with a certificate supplied by an administrator, rewriting descriptor files for each component with contents required by a target platform, performing at least one of implementing a user supplied feature/plugin and triggering a feature/plugin packager for creating a feature/plugin, running the application on the client and synchronizing data between the client and the application server.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to Eclipse-based Rich Clients, and particularly to systems, methods and computer program products for automating packaging and provisioning of J2EE Web Modules to Eclipse-based Rich Clients.

2. Description of Background

Eclipse is an open source community whose projects are focused on building an open development platform comprised of extensible frameworks, tools and runtimes for building, deploying and managing software across the lifecycle. The Rich Client Project (RCP) provides an elegant way to build highly-configurable, GUI-standards-following rich-client applications faster by leveraging the Spring Framework, and a rich library of UI factories and support classes. A portlet container provides a runtime environment for portlets implemented according to the Portlet API. Currently, there exists technology on the Rich Client to run portlet applications in the Portlet Container. In order to run portlet applications in the Portlet Container, a J2EE Web Module is transformed into an OSGI bundle (i.e., to WAB-ify (Web Archive Bundle) the portlet). In addition, a different packaging model is needed to deploy to the Rich Client. However, the web module transformation and the packaging module steps require manual non-automatic steps, which introduce errors into the process. Currently, some toolkits are available to make it easier to package the bundles, however they are very specialized and difficult to use for non-technical users. In addition, once the bundles are created, the deployment to an Eclipse Update Site for provisioning (i.e., sending the features and plugins necessary to run a piece of software from the server to the client) to a rich client can require several manual steps and configuration. Furthermore, the above-discussed steps have to be repeated each time the application is modified by the developers.

### SUMMARY OF THE INVENTION

Exemplary embodiments include a method for automating packaging and provisioning of J2EE Web Modules to a Eclipse-based Rich Client, the method including deploying a J2EE Web application to an application server being packaged as a plugin sent to the Eclipse-based Rich Client via a dynamic update site having a feature/plugin packager, publishing the J2EE Web Application to the dynamic update site, connecting to the dynamic update site, selecting the J2EE Web application having the J2EE Web Modules for provisioning, versioning each component of the J2EE application, determining interdependencies of each component, determining user access control for each component, generating feature and plugin jar files from each component, signing the feature and plugin jar files with a certificate supplied by an administrator, rewriting descriptor files for each component with contents required by a target platform, performing at least one of implementing a user supplied feature/plugin and triggering the feature/plugin packager for creating a feature/plugin, running the application on the Eclipse-based Rich Client and synchronizing data between the local client and the application server.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### Technical Effects

As a result of the summarized invention, technically we have achieved a solution which includes provides automated packaging and publishing of the J2EE web application to the dynamic update site that removes problems due to human error, thus increasing developer productivity and reducing administration costs. The solution further includes automated versioning, repackaging and republishing when the J2EE application is modified that increases application availability for customers. For greater flexibility and customization, the system allows for manual packaging and publishing to Eclipse Update Site of choice.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates an exemplary embodiment of a system for automating packaging and provisioning of J2EE Web Modules to Eclipse-based Rich Clients.

FIG. 2 illustrates a flow chart of a method for automating packaging and provisioning of J2EE Web Modules to Eclipse-based Rich Clients in accordance with exemplary embodiments;

FIG. 3 illustrates a block diagram of sub-components working together during as described with respect to FIG. 2; and

FIG. 4 illustrates a block diagram of a dynamic update site that follows the Eclipse Update Manager protocol in accordance with exemplary embodiments.

The detailed description explains the preferred embodiments of the invention, together with advantages and features, by way of example with reference to the drawings.

### DETAILED DESCRIPTION OF THE INVENTION

In exemplary embodiments, the systems and methods described herein automate the two above-described steps (i.e., automated packaging and publishing of the J2EE web application to the dynamic update site and automated versioning, repackaging and republishing when the J2EE application is modified that increases application availability for customers) without requiring the user to do any extra steps beyond deploying the application to the J2EE application server. At the same time, the systems and methods described herein provide the flexibility to manually override some of the steps by, for example, allowing code customized to the Rich Client to be included in the generated bundles. In exemplary embodiments, the systems and methods described herein further automatically detect changes made to the application and repackage the bundles appropriately.

In exemplary embodiments, the systems and methods described herein make a J2EE Web Module available for provisioning as an Eclipse Feature, without any extra steps besides deploying the Web Module (i.e., war file) to the application server. In exemplary embodiments, the systems and methods described herein include the following components: 1) a dynamic Update Site, which can be an Eclipse update site that automatically updates itself based on the web modules deployed in the application server as well as the access rights for the current user; and 2) a bundle packager, which packages the web module into an OSGI bundle that contains all the necessary extension points adapted to the target platform. The component also provides the following features: automated dependency management, jar signing, versioning, and ACL management.

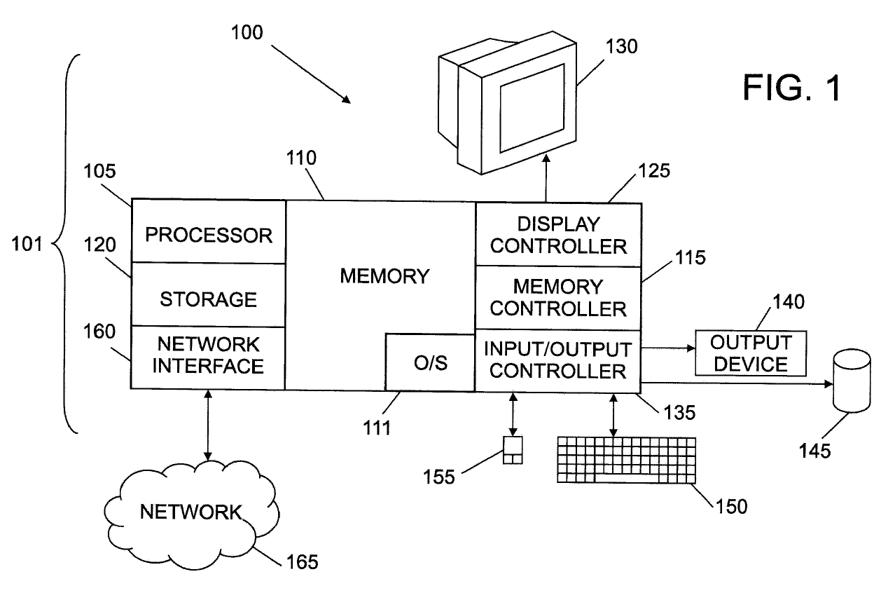

FIG. 1 illustrates an exemplary embodiment of a system 100 automating packaging and provisioning of J2EE Web Modules to Eclipse-based Rich Clients. The methods described herein can be implemented in software (e.g., firmware), hardware, or a combination thereof. In exemplary embodiments, the methods described herein are implemented in microcode, as an executable routine that is executed by a special or general-purpose digital computer, such as a personal computer, workstation, minicomputer, or mainframe computer. The system 100 therefore includes general-purpose computer 101.

In exemplary embodiments, in terms of hardware architecture, as shown in FIG. 1, the computer 101 includes a processor 105, memory 110 coupled to a memory controller 115, and one or more input and/or output (I/O) devices 140, 145 (or peripherals) that are communicatively coupled via a local input/output controller 135. The input/output controller 135 can be, for example but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing software instructions. It is appreciated that the processor 105 can include a plurality of registers including GPRs, FPRs, scratch registers, etc.

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The software in memory 110 may include one or more separate programs, each of which comprises an ordered listing of executable instructions for implementing logical functions. In the example of FIG. 1, the software in the memory 110 includes the automated packaging and provisioning methods described herein in accordance with exemplary embodiments and a suitable operating system (OS) 111. The operating system 111 essentially controls the execution of other computer programs, such the automated packaging and provisioning systems and methods described herein, and provides scheduling, input-output control, file and data management, memory management, and communication control and related services.

The automated packaging and provisioning methods described herein may be in the form of a source program, executable program (object code), script, or any other entity comprising a set of instructions to be performed. When a source program, then the program needs to be translated via a compiler, assembler, interpreter, or the like, which may or may not be included within the memory 110, so as to operate properly in connection with the OS 111. Furthermore, the automated packaging and provisioning methods can be written as an object oriented programming language, which has classes of data and methods, or a procedure programming language, which has routines, subroutines, and/or functions.

In exemplary embodiments, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 100 can further include a display controller 125 coupled to a display 130. In exemplary embodiments, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In exemplary embodiments, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the software in the memory 110 may further include a basic input output system (BIOS) (omitted for simplicity). The BIOS is a set of essential software routines that initialize and test hardware at startup, start the OS 111, and support the transfer of data among the hardware devices. The BIOS is stored in ROM so that the BIOS can be executed when the computer 101 is activated.

When the computer 101 is in operation, the processor 105 is configured to execute software stored within the memory 110, to communicate data to and from the memory 110, and to generally control operations of the computer 101 pursuant to the software. The automated packaging and provisioning methods described herein and the OS 111, in whole or in part, but typically the latter, are read by the processor 105, perhaps buffered within the processor 105, and then executed.

When the systems and methods described herein are implemented in software, as is shown in FIG. 1, it the methods can be stored on any computer readable medium, such as storage 120, for use by or in connection with any computer related system or method. In the context of this document, a computer readable medium is an electronic, magnetic, optical, or other physical device or means that can contain or store a computer program for use by or in connection with a computer related system or method. The automated packaging and provisioning methods described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In exemplary embodiments, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In exemplary embodiments, where the automated packaging and provisioning methods are implemented in hardware, the automated packaging and provisioning methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

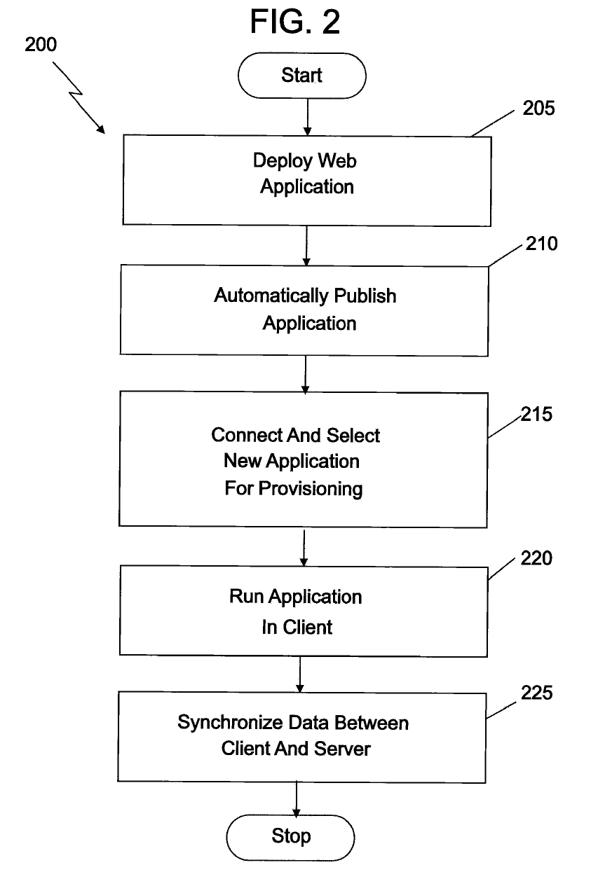

FIG. 2 illustrates a flow chart of a method for automating packaging and provisioning of J2EE Web Modules to Eclipse-based Rich Clients in accordance with exemplary embodiments. At block 205, a developer or administrator deploys the J2EE Web application to the Application server. At block 210, once the J2EE Web application is deployed, the systems described herein automatically publish the newly deployed application to the dynamic update site. At block 215, from the Eclipse-based Rich client, the end user uses the Eclipse Update Manager (i.e., the Eclipse component) to connect to the Designer Dynamic Eclipse Update Site (DUS) and to select the new application for provisioning. In further exemplary embodiments, provisioning can be triggered automatically based on which applications the user is allowed to use (e.g., Lotus expeditor shows a list of applications in a simple user interface and upon the user double clicking on the application, the system determines whether to trigger a provisioning from the DUS. The term “component” is used interchangeably with the term “application” herein, which is equivalent to a J2EE Web Module deployed on the application server. In exemplary embodiments, the Eclipse Update Manager connects to the Eclipse Update Site to discover new applications and provision (download) them to the local client. In addition, the DUS is the subsystem that creates the Eclipse Update Site on demand. At block 220, once provisioned, the application can run in the local client in the exact same way as in the server. At block 225, optionally, data can be synchronized between the server and the client.

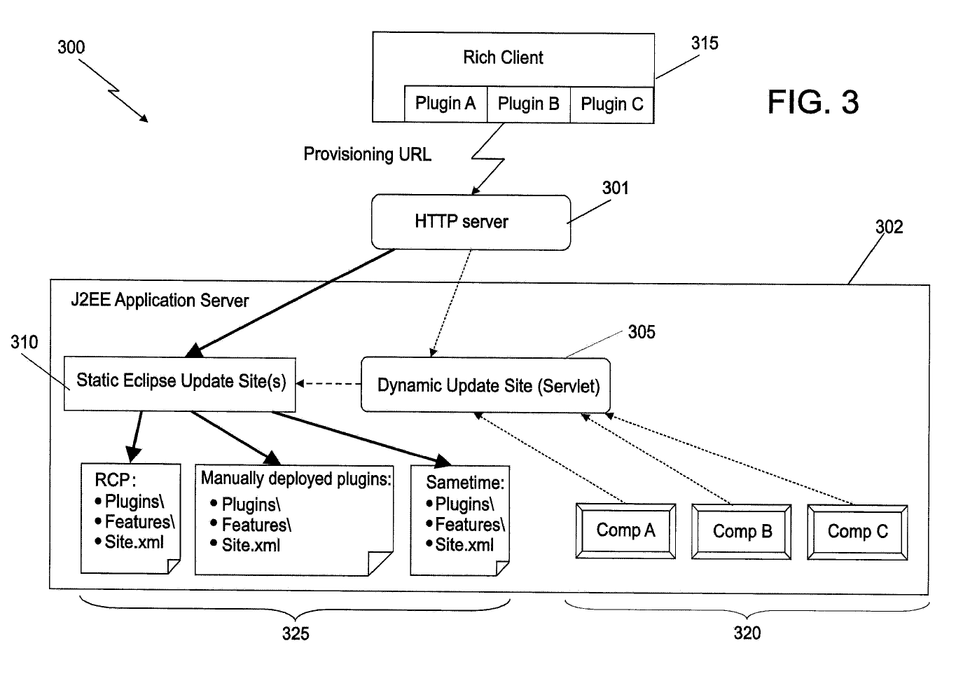

FIG. 3 illustrates a block diagram 300 of sub-components working together during as described with respect to FIG. 2. In exemplary embodiments, the provisioning can be originated from the Dynamic Update Site (DUS) 305 or a statically update site 310 based on the administrator preferences. FIG. 3 further illustrates each component deployed on the application server being packaged as a plugin sent to the Rich Client 315 via the DUS 305 or a static Eclipse Update Site 310 through an HTTP server 301. In exemplary embodiments, the user also has the option to manually package the component 320 as a plugin 325 (e.g., to provide customization), in which case, the DUS does not automatically package the plugin but, rather, uses the one supplied by the user. In exemplary embodiments, the DUS can be implemented as a servlet.

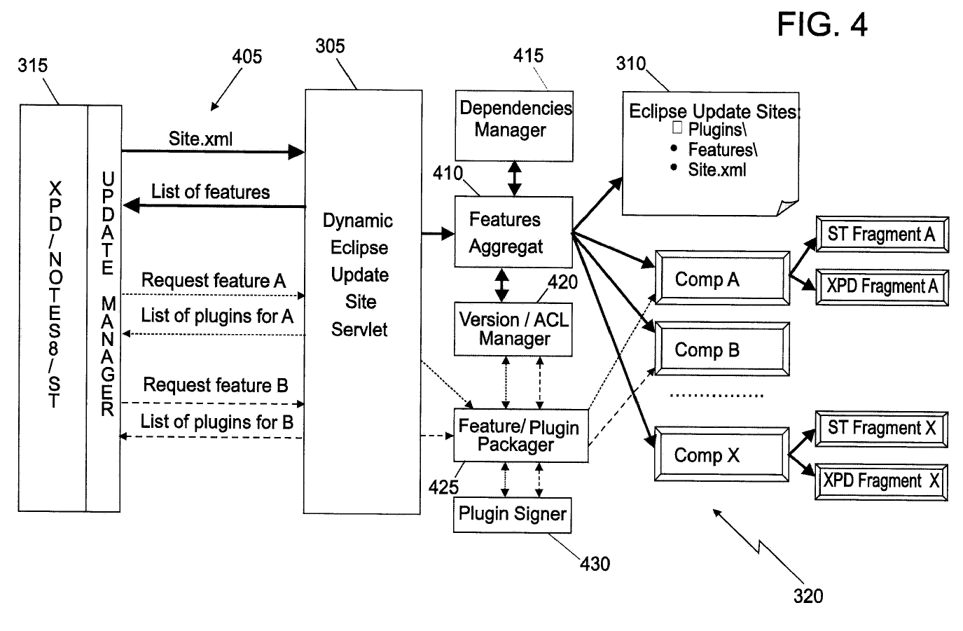

FIG. 4 illustrates a block diagram of a DUS 305 that follows the Eclipse Update Manager protocol in accordance with exemplary embodiments. In exemplary embodiments, the client 315 is requesting the site.xml file 405. The DUS 305 responds by generating on the fly a site.xml by introspecting the J2EE Application server 302 for deployed components 320, each having ST and XPD fragments. Each component is associated with a feature that is automatically versioned. When the client 315 is requesting a feature or plugin 325, the DUS 305 first looks in the deployed component 320 to check if a custom one has been supplied by the owner of the component 320, and, if so, automatically uses the feature or plugin 325. In the case none has been supplied, then the DUS 305 looks in its own cache to check if one can be reused and, if none, triggers the Feature/Plugin packager sub-component for creating a new one and put it in the cache. It is appreciated that there are many options for invalidating the cache in exemplary embodiments. For any of the options implemented, the cache is invalidated if any of the code, resources or descriptor file has been modified since the last time the plugin was generated in the cache.

In exemplary embodiments, the DUS 305 includes several sub-components including but note limited to: 1) feature aggregators 410; 2) a dependencies manager 415; 3) a version manager 420; 4) a pluginID; 5) an ACL manager; 6) a feature/plugin packager 425; and 7) a plugin signer 430. In exemplary embodiments, the feature aggregator 410 is a module used by DUS 305 during the generation of the site.xml. In exemplary embodiments, the dependencies manager 415 is a module used to determine dependencies to other components. Any dependencies detected are referenced in the feature.xml descriptor file, causing the client to provision the other component as well. In exemplary embodiments, the version manager 420 is a module responsible for automatically assigning a version to a feature and plugin. The Dynamic Update Site is using the qualifier technique defined since Eclipse 3.2 to qualify the feature and plugin version packaged for the component: <<pluginID>>_<<version>>.vYYYYMMDDHHmm. In exemplary embodiments, the pluginID and version are taken from the plugin.xml or manifest.mf descriptor file. In the case one of these descriptor file is not present in the J2EE component, a default value is provided as follow: <<componentName>>. Every time the component is updated, the version is recalculated according to the following scheme: YYYYMMDDHHmm. For example: myapp._{—}1.0.0.v200606060134. Both the pluginID and version can be overridden by the developer user. In exemplary embodiments, the ACL manager is a module responsible for determining user access control to a particular component. If the current user doesn't have enough rights, then the component doesn't appear in the site.xml manifest. In exemplary embodiments, the feature/plugin packager 425 is a module responsible for generating the feature and plugin jar files from the deployed J2EE Component. This module is described in more detail herein. In exemplary embodiments, the plugin signer 430 is an optional module that automatically sign the feature and plugin jar file with a certificate supplied by the administrator.

In exemplary embodiments, the feature/plugin packager 425 is responsible for packaging the feature and plugin jar files that are sent to the client. Besides gathering all the files, the feature/plugin packager 425 also rewrites the descriptor files with the contents required by the target platform. For example, adding the required extension points, package dependencies, etc.

In exemplary embodiments, the system allows for complete customization of the descriptor file rewriting. For example, the application owner can add extension points specific to a particular target platform. In exemplary embodiments, the descriptor files that are rewritten during this phase include but are not limited to: plugin.xml; manifest.mf; web.xml; and portlet.xml. In exemplary embodiments, the plugin/feature options include but are not limited to: a feature Label (a descriptive label for the feature); a provider-name (plugin provider); image (path to an image); copyright; license Information; category definition (category in which the feature appear in the Eclipse Update Manager). In exemplary embodiments, the user can provide eclipse fragments to customize for each support target platform. In exemplary embodiments, fragments must be deployed in a pre-defined directory and follow a specific naming convention, for the DUS to recognize them. An example implementation could be to use the WEB-INF\fragments directory and the name of the component followed by the target platform id, is as follows:

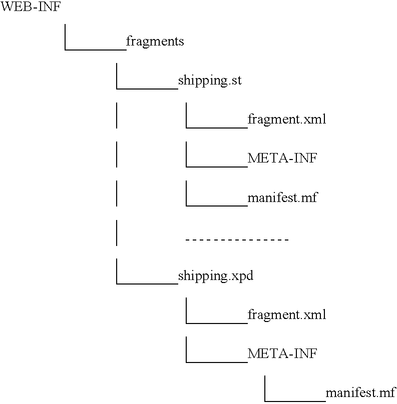

In exemplary embodiments, during provisioning, the DUS 305 looks into the WEB-INF\fragments directory of the application to check if a fragment is present for the client platform being provisioned to and if it's the case, then the fragment is automatically be added to the generated feature.

In exemplary embodiments, the user can provide properties files that contain the translation for all the plugin/feature options described above. Similarly, the user can also provide properties files for all the standard eclipse descriptor files like plugin properties, etc. The DUS automatically recognizes them and package them into the generated features and plugins according to Eclipse conventions.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A method for automating packaging and provisioning of J2EE Web Modules to an Eclipse-based Rich Client, the method consisting of:
deploying a J2EE Web application to an application server, the J2EE Web application being packaged as a plugin sent to the Eclipse-based Rich Client via a dynamic update site having a feature/plugin packager;
publishing the J2EE Web Application to the dynamic update Eclipse site;
connecting to the dynamic update Eclipse site;
selecting the J2EE Web application having the J2EE Web Modules for provisioning;
versioning each component of the J2EE application;
determining interdependencies of each component;
referencing interdependent components in a descriptor file and generating the interdependent components;
determining user access control for each component;
generating feature and plugin jar files from each component;
signing the feature and plugin jar files with a certificate supplied by an administrator;
rewriting descriptor files for each component with contents required by a target platform;
performing at least one of implementing a user supplied feature/plugin and triggering the generated feature/plugin packager for creating a feature/plugin, the triggering being based on the user access control for each component;
running the application on the Eclipse-based Rich Client; and
synchronizing data between the local client and the application server, such that the J2EE application runs synchronously on the Eclipse-based Rich Client and the application server;
wherein the dynamic update Eclipse site automatically updates itself based on the J2EE Web Modules deployed in the application server.
